(19) United States
(12) Patent Application Publication
(10) Pub. No.: US 2015/0083091 A1
(43) Pub. Date: Mar. 26, 2015

(54) ARRANGEMENT OF AN INTERCOOLER IN AN INTAKE PIPE

(71) Applicant: BEHR GMBH & CO. KG, Stuttgart (DE)

(72) Inventors: Matthias Fehrenbach, Stuttgart (DE); Werner Helms, Esslingen (DE); Rüdiger Kölblin, Esslingen (DE); Christian Saumweber, Stuttgart (DE)

(73) Assignee: BEHR GMBH & CO. KG, Stuttgart (DE)

(21) Appl. No.: 14/394,294

(22) PCT Filed: Apr. 10, 2013
(86) PCT No.: PCT/EP2013/057509

§ 371 Date: Oct. 14, 2014

(30) Foreign Application Priority Data
Apr. 13, 2012 (DE) 10 2012 206 106.1

(51) Int. Cl. F02B 29/04

(52) U.S. Cl. CPC F02B 29/045
USPC 123/542; 123/563

(57) ABSTRACT

The invention relates to an arrangement of a charge air cooler in an intake pipe, wherein the charge air cooler has a cooler block through which charge air can flow and the charge air cooler can be inserted into the intake pipe through a first opening in said intake pipe, wherein the cooler block has at least one first outer wall and at least one second outer wall, which outer walls run along the main direction of extent of the cooler block and bound the region of the cooler block through which charge air can flow, wherein the intake pipe surrounds, on three sides, that part of the charge air cooler which can be inserted, so that charge air can flow through the cooler block of the charge air cooler within the intake pipe.

### TECHNICAL FIELD

The invention relates to an arrangement of a charge air cooler in an intake pipe, wherein the charge air cooler has a cooler block through which charge air can flow and the charge air cooler can be inserted into the intake pipe through a first opening in said intake pipe, wherein the cooler block has at least one first outer wall and at least one second outer wall, which outer walls run along the main direction of extent of the cooler block and bound the region of the cooler block through which charge air can flow, wherein the intake pipe surrounds, on three sides, that part of the charge air cooler which can be inserted, so that charge air can flow through the cooler block of the charge air cooler within the intake pipe, wherein the intake pipe has a first inner surface and a second inner surface, said inner surfaces each running along one of the outer walls of the cooler block.

### PRIOR ART

Charge air coolers are used for cooling the charge air in charged motors. This is necessary since the intake air is heated owing to the compression in a turbocharger. This leads to a reduction in the density of the intake air. This effectively leads to a lower oxygen content in the combustion space charge.

In contrast to compression, cooling by the charge air cooler causes an increase in the density, as a result of which intake air with a high density is supplied to the combustion space of the internal combustion engine. The content of oxygen which is required for the combustion is particularly high in air with a high density.

In order to achieve the greatest possible advantage by virtue of cooling the intake air, it is expedient to position the charge air cooler as close to the inlet valves as possible, in order to avoid subsequent heating of the air as far as possible.

In modern applications in the automobile industry, the arrangement of the charge air cooler in the intake pipe of the internal combustion engine has become established for this purpose. In this case, the charge air cooler is usually inserted into the intake pipe through a lateral opening and is fastened to the intake pipe by means of a connection flange which is generally connected to the charge air cooler in an interlocking manner.

A second bearing for the charge air cooler can be provided within the intake pipe on that wall of the intake pipe which is situated opposite the insertion opening.

Solutions of this kind are currently implemented in in-line engines with three and four cylinders. The same is true in the case of internal combustion engines with V-shaped cylinder banks with six or eight cylinders.

One disadvantage of the prior art is that, owing to this manner of installation, vibrations at the intake pipe and stresses, which can be produced owing to tolerances which are not 100% between the flange of the charge air cooler and the intake pipe, are transmitted directly to the charge air cooler.

Owing to the sometimes long lengths of the charge air cooler and the fact that an exact right angle can be found between the matrix of the charge air cooler and the flange of the charge air cooler only in a very small number of cases, more or less large deflections of the charge air cooler out of the central position may occur. The longer the charge air cooler, the greater this deflection out of the central plane may be.

This can lead to considerable problems in respect of the positioning of the charge air cooler in the necessarily required second bearing on the opposite side of the intake pipe, particularly in designs with long charge air coolers and only one opening in the intake pipe.

In addition, bearing, in particular of long charge air coolers, at only two bearing points is inadequate on account of the severe vibrations which occur.

The embodiments known from the prior art have reached their limits, in particular in respect of the future use of intake pipe-integrated charge air coolers for in-line 6-cylinder engines.

### DESCRIPTION OF THE INVENTION, PROBLEM, SOLUTION AND ADVANTAGES

The problem addressed by the present invention is therefore that of providing an arrangement of a charge air cooler in an intake pipe, which arrangement allows even long charge air coolers to be fitted in the intake pipe in a simple and secure manner. It is also an objective to provide an installation concept which is particularly advantageous for the charge air cooler in respect of the shocks and vibrations which occur.

The problem addressed by the present invention is solved by an arrangement of a charge air cooler in an intake pipe having the features as claimed in claim 1. Advantageous developments of the present invention are defined in the dependent claims.

An arrangement of a charge air cooler in an intake pipe, wherein the charge air cooler has a cooler block through which charge air can flow and the charge air cooler can be inserted into the intake pipe through a first opening in said intake pipe, wherein the cooler block has at least one first outer wall and at least one second outer wall, which outer walls run along the main direction of extent of the cooler block and bound the region of the cooler block through which charge air can flow, wherein the intake pipe surrounds, on three sides, that part of the charge air cooler which can be inserted, so that charge air can flow through the cooler block of the charge air cooler within the intake pipe, wherein the intake pipe has a first inner surface and a second inner surface, said inner surfaces each running along one of the outer walls of the cooler block, wherein the first inner surface and/or the second inner surface each have a first projection against which the first outer wall and/or the second outer wall of the cooler block can be supported, is advantageous.

It is further advantageous when the first projection of the first and/or second inner surface in each case has a damping element by means of which the first outer wall and/or the second outer wall of the cooler block can be supported. This can result in additional decoupling of the charge air cooler from the vibrations which occur during operation. This is beneficial for the service life of the charge air cooler.

It is also preferred when the first inner surface and/or the second inner surface have/has a plurality of projections by means of which the first outer wall and/or the second outer wall of the cooler block can be supported. A plurality of projections increases the number of bearing points at which the charge air cooler can be supported. This leads to relatively small relative movements of the charge air cooler within the intake pipe and to a relatively high resistance of the charge air cooler to shocks from the outside.

In an alternative embodiment, it is advantageous when the plurality of projections of the first inner surface and/or of the second inner surface have damping elements by means of which the first outer wall and/or the second outer wall of the cooler block can be supported. Additional damping elements can increase the decoupling of the charge air cooler from the intake pipe, as a result of which shocks which act on the charge air cooler from the outside are reduced.

It is further preferred when the position of the at least first projection on the first inner surface and/or on the second inner surface is matched to the eigenmodes and natural oscillations of the charge air cooler. Oscillation amplitudes of the charge air cooler can be minimized as a result of the bearing points being matched to the natural oscillations of the charge air cooler. This serves to increase the service life of the charge air cooler. An arrangement of this kind can also be used to prevent resonance oscillations of the charge air cooler which, under unfavorable circumstances, can lead to damage to the charge air cooler and even to the intake pipe.

It is also advantageous when the at least first projection of the first inner surface and/or of the second inner surface are formed integrally with the intake pipe. This means, in particular, advantages in the production process.

It is also advantageous when the first outer wall and/or the second outer wall of the cooler block have/has a first elastic damping element by means of which the first inner surface and/or the second inner surface can be supported. Said damping element firstly increases the decoupling of the charge air cooler from the intake pipe, and secondly increases sealing of the charge air cooler with respect to the inner surfaces of the intake pipe, as a result of which the proportion of the air flowing laterally past the charge air cooler is reduced.

### BRIEF DESCRIPTION OF THE DRAWINGS

The invention will be explained in greater detail below using an exemplary embodiment with reference to the drawing. In the

### DRAWING

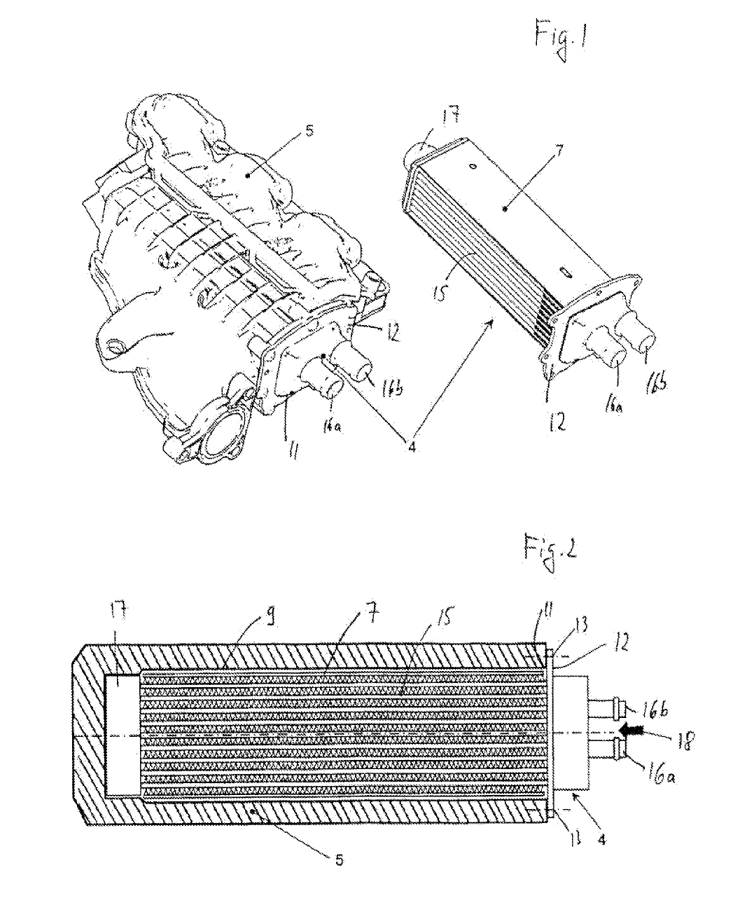

FIG. 1 shows, in the left-hand half, a perspective view of an intake pipe of an internal combustion engine with a charge air cooler installed, and also, in the right-hand half, the charge air cooler in the removed state,

FIG. 2 shows a section through the center plane of the charge air cooler and of the intake pipe in the installed state shown in FIG. 1,

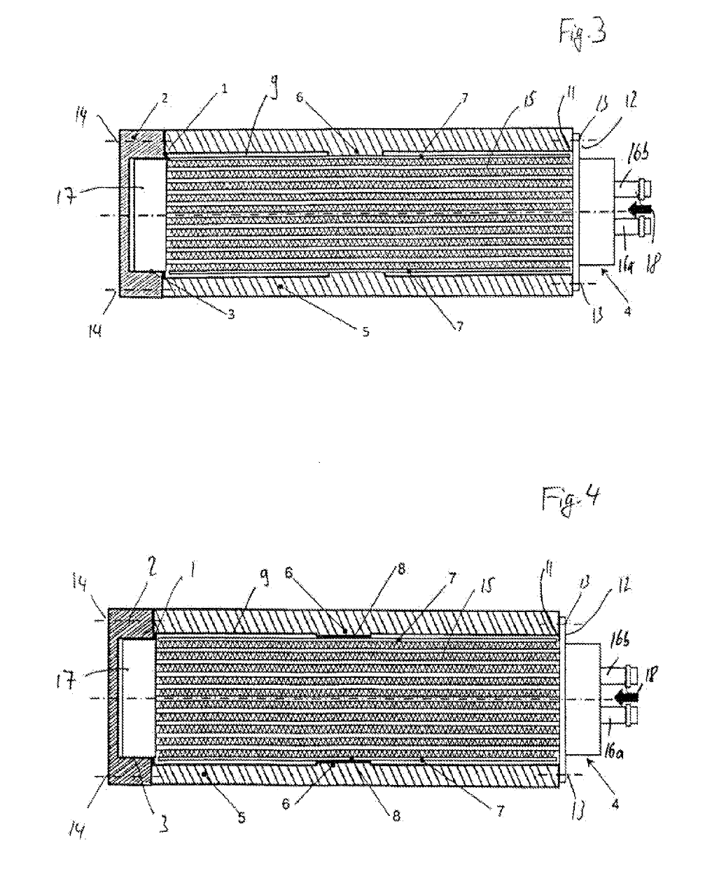

FIG. 3 shows a section through the center plane of a charge air cooler and of an intake pipe in one embodiment according to the invention,

FIG. 4 shows a section through the center plane of a charge air cooler and of an intake pipe in a further embodiment according to the invention,

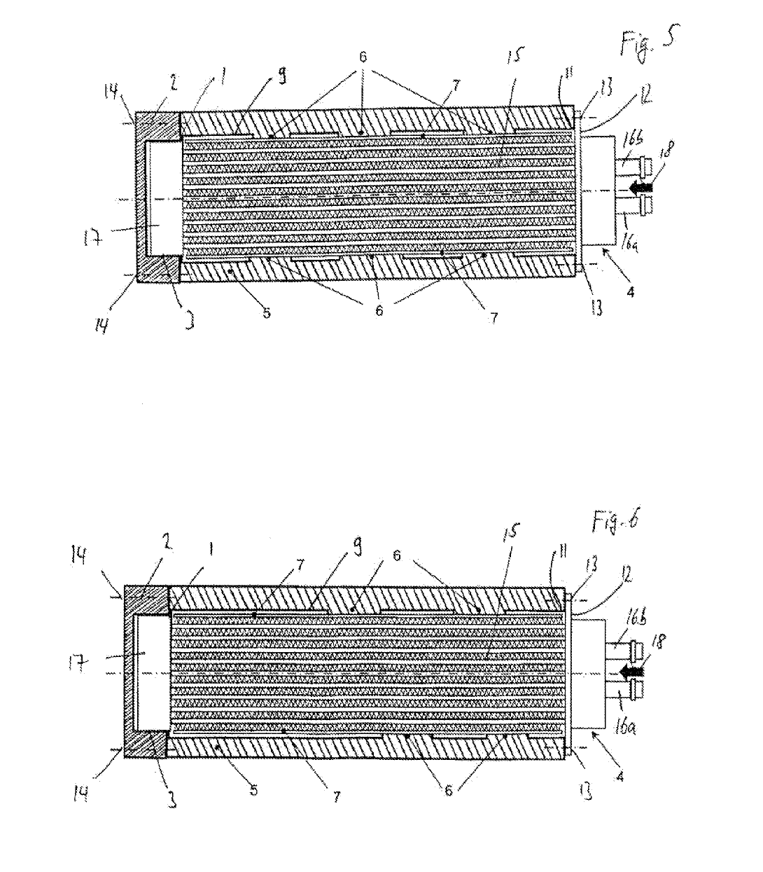

FIG. 5 shows a section through the center plane of a charge air cooler and of an intake pipe in a further embodiment according to the invention,

FIG. 6 shows a section through the center plane of a charge air cooler and of an intake pipe in a further embodiment according to the invention,

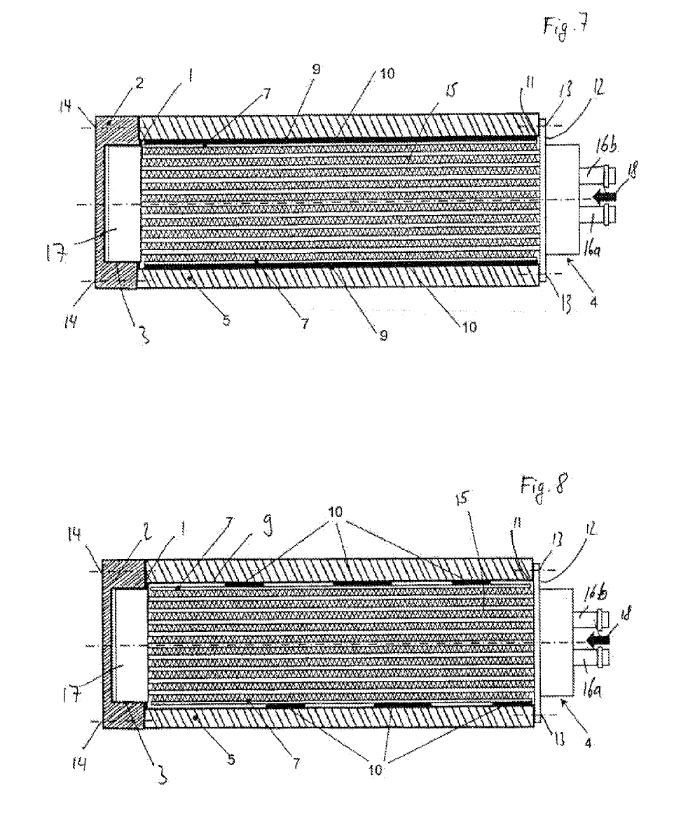

FIG. 7 shows a section through the center plane of a charge air cooler and of an intake pipe in a further embodiment according to the invention, and

FIG. 8 shows a section through the center plane of a charge air cooler and of an intake pipe in a further embodiment according to the invention.

### PREFERRED EMBODIMENT OF THE INVENTION

FIG. 1 shows, in the left-hand half of the image, a perspective outside view of an intake pipe 5. Said intake pipe 5 serves to supply air to an internal combustion engine, not shown in the figure. Compression of the intake air in a turbocharger or a compressor heats the air. As a result, the density of the air is reduced, and this would lead to relatively poor filling of the combustion spaces in the internal combustion engine. A charge air cooler 4 is installed in the intake pipe 5 for the purpose of cooling the air which is supplied to an internal combustion engine via the intake pipe 5 and therefore of increasing the density of the intake air.

The more precise internal design of the intake pipe 5 is not described in further detail at this point since it is not essential to the invention. The installation principle of the charge air cooler 4 in the intake pipe 5 is clear from the drawing on the left-hand side of FIG. 1.

The right-hand half of FIG. 1 shows the installed charge air cooler 4. The charge air cooler 4 shown in FIG. 1 corresponds, in respect of its design, to the charge air coolers known from the prior art. In addition to a cooler block 15, which comprises a large number of cooling pipes through which coolant flows and around which air which is to be cooled flows, the charge air cooler 4 has outer walls 7.

A flange plate 12 is attached to the side of one of the header boxes of the charge air cooler 4. Said flange plate serves to fasten the charge air cooler 4 to the intake pipe 5. The charge air cooler 4 further has two coolant connection pieces 16a, 16b. A centering means 17 which serves to additionally mount the charge air cooler 4 in the intake pipe 5 is arranged at that end of the charge air cooler 4 which is situated opposite the flange plate 12.

The further detailed design of the charge air cooler is not further described at this point since it is not essential to the invention.

In further advantageous embodiments, the use of different charge air coolers of different designs is feasible. For example, the use of U-shaped charge air coolers with a deflection in the interior, but also the use of a charge air cooler through which charge air flows in a straight line without deflection, said charge air coolers having the inlet and the outlet at opposite ends.

FIG. 2 shows a section through the center plane of the installed charge air cooler 4 in the intake pipe 5. Said figure shows, in particular, the section through the intake pipe 5 which has intake pipe inner walls 9. In this case, the internal region of the intake pipe 5 has dimensions which allow the charge air cooler 4 to be pushed in. A recess in the intake pipe is provided at that end of the intake pipe 5 which is situated opposite the insertion opening, said recess serving to receive the centering means 17 which is attached to one of the outer ends of the charge air cooler 4.

In the inserted state, the flange plate 12 terminates flush with the outer wall of the intake pipe 5 and can be fixed to the intake pipe 5 by means of the screw systems 13.

The use of a sealing means, for example an O-ring seal, is provided in order to seal off the connection of the charge air cooler 4 to the intake pipe 5.

The cooler block 15 is therefore effectively subjected to the action of the air stream which flows in the interior of the intake pipe 5, this promoting heat transfer from the air which flows through said cooler block to the cooling medium which flows in the interior of the charge air cooler 4.

The embodiment of FIG. 2 constitutes the current state of the art with all of the disadvantages described in the introductory part.

FIGS. 3 to 8 which now follow each constitute different embodiments of an arrangement according to the invention of the charge air cooler in the intake pipe. All of the further figures each show, analogously to FIG. 2, a section through the intake pipe 5 with the fitted charge air cooler 4.

The reference symbols in FIGS. 2 to 8 largely correspond, and deviations which are specific to a figure will be mentioned separately in the respective description of the figure.

In FIG. 3, the intake pipe 5 has projections 6 on the inner walls 9. In the shown embodiment, the two projections 6 are arranged on the intake pipe inner walls 9 centrally halfway along the length of the pushed-in charge air cooler 4.

In a departure from the intake pipe 5 illustrated in FIG. 1 and the arrangement of the intake pipe 5 and of the fitted charge air cooler 4 illustrated in FIG. 2, FIG. 3 illustrates an intake pipe 5 having two opposite openings 1, 11. The opening 1, which is situated opposite the opening 11, in the intake pipe 5 is illustrated in addition to the insertion opening 11 through which the charge air cooler is inserted into the intake pipe 5.

Said second opening 1, and also the housing part 2 which closes the opening 1, are mentioned at this point only for better understanding of the figures. The housing part 2 has a bearing point 3 into which the charge air cooler 4 can be inserted. The housing part 2 is further fastened to the intake pipe by means of screw systems 14. The second opening 1 and also the housing part 2 are not essential to the invention and therefore will not be included in the further description of the figures.

The projections 6, shown in FIG. 3, of the intake pipe inner walls 9 are in direct contact with the outer surfaces 7 of the cooler block 15 in the fitted state. Owing to an assembly arrangement of this kind, as shown in FIG. 3, the charge air cooler 4 is mounted at four points in the installed state, specifically at the projections 6, at the bearing point 3 of the housing part 2 and by the screw system 13 of the flange plate 12 of the charge air cooler 4. This leads to the charge air cooler being secured in the intake pipe 5 in a particularly shock-resistant manner, this being beneficial in respect of a relatively long service life of the charge air cooler.

FIG. 4 shows a drawing which is analogous to FIG. 3. In FIG. 4, the projections 6, which are arranged on the intake pipe inner walls 9, are now lined with an additional damping element 8. In this way, the outer walls 7 of the charge air cooler are not supported directly on the projections 6, but rather indirectly by means of the additional damping element 8.

Said additional damping element 8 therefore makes a contribution to decoupling the charge air cooler 4 from the intake pipe 5. As a result, the transmitted vibrations of the intake pipe 5, which are inevitably produced by the direct connection to the internal combustion engine, are not all transmitted to the charge air cooler 4.

In further embodiments according to the invention, a plurality of projections 6 can also be arranged on the intake pipe inner walls 9. This is illustrated, for example, in FIG. 5. Said projections can be situated directly opposite one another on the top face and the bottom face of the intake pipe 5, but the projections 6 can also be designed to be offset in relation to one another. This is shown, inter alia, in FIG. 6.

In a further advantageous embodiment, it would likewise be feasible to provide each of the projections 6 from FIGS. 5 and 6 with the additional damper elements 8, as are illustrated in FIG. 4. The distribution of the projections 6 over the intake pipe inner walls 9 can be influenced by various factors. One approach, amongst others, may be a design in accordance with the vibration modes which the charge air cooler 4 exhibits during operation.

In this case, it is particularly advantageous to arrange the projections 6 in regions of maximum vibration amplitude of the charge air cooler 4. In this way, the charge air cooler 4 can be better and more effectively insulated against vibrations and oscillation phenomena which are transmitted to the charge air cooler 4 by the intake pipe 5.

FIGS. 7 and 8 show, in principle, a similar design to that in FIGS. 3 to 6, but FIGS. 7 and 8 do not have any projections 6. Instead of the projections 6 on the intake pipe inner walls 9, the outer walls 7 of the charge air cooler 4 have elastic elements in this case, the charge air cooler being supported against the intake pipe inner walls 9 of the intake pipe 5 by means of said elastic elements in the inserted state.

In this case, the elastic elements 10 are designed such that they can be inserted into the insertion openings 11 together with the charge air cooler 4 owing to their ability to yield. FIG. 7 illustrates elastic elements 10 which are fitted over the entire length of the charge air cooler 4. However, it is likewise also feasible to apply the elastic elements only to sections of the outer surfaces 7 of the charge air cooler 4.

In an alternative embodiment, it is likewise feasible to apply the elastic elements 10 to the intake pipe inner walls 9 and then to push the charge air cooler 4 into the intake pipe 5. However, this should really be avoided for production-related reasons. It is generally feasible to distribute and arrange the elastic elements 10 in many different ways.

1. An arrangement of a charge air cooler in an intake pipe, wherein the charge air cooler has a cooler block through which charge air can flow and the charge air cooler can be inserted into the intake pipe through a first opening in said intake pipe, wherein the cooler block has at least one first outer wall and at least one second outer wall, which outer walls run along the main direction of extent of the cooler block and bound the region of the cooler block through which charge air can flow, wherein the intake pipe surrounds, on three sides, that part of the charge air cooler which can be inserted, so that charge air can flow through the cooler block of the charge air cooler within the intake pipe, wherein the intake pipe has a first inner surface and a second inner surface, said inner surfaces each running along one of the outer walls of the cooler block, wherein the first inner surface and/or the second inner surface each have a first projection against which the first outer wall and/or the second outer wall of the cooler block can be supported.

2. The arrangement as claimed in claim 1, wherein the first projection of the first and/or second inner surface in each case have a damping element by means of which the first outer wall and/or the second outer wall of the cooler block can be supported.

3. The arrangement as claimed in claim 1, wherein the first inner surface and/or the second inner surface have/has a plurality of projections by means of which the first outer wall and/or the second outer wall of the cooler block can be supported.

4. The arrangement as claimed in claim 3, wherein the plurality of projections of the first inner surface and/or of the second inner surface have damping elements by means of which the first outer wall and/or the second outer wall of the cooler block can be supported.

5. The arrangement as claimed in claim 1, wherein the position of the at least first projection on the first inner surface and/or on the second inner surface is matched to the eigenmodes and natural vibrations of the charge air cooler.

6. The arrangement as claimed in claim 1, wherein the at least first projection of the first inner surface and/or of the second inner surface are designed integrally with the intake pipe.

7. The arrangement as claimed in claim 1, wherein the first outer wall and/or the second outer wall of the cooler block have/has a first elastic damping element by means of which the first inner surface and/or the second inner surface can be supported.
